(19) United States
(12) Patent Application Publication
(10) Pub. No.: US 2019/0335169 A1
(43) Pub. Date: Oct. 31, 2019

(54) METHOD FOR INTELLIGENTLY CONFIGURING VIDEO SETTINGS

(71) Applicant: AVerMedia TECHNOLOGIES, INC., New Taipei City (TW)

(72) Inventor: Hsiang-Yi MA, New Taipei City (TW)

(21) Appl. No.: 16/373,584

(22) Filed: Apr. 2, 2019

(30) Foreign Application Priority Data
Apr. 30, 2018 (TW) 107114738

(51) Int. Cl. H04N 17/04; H04N 9/64; H04N 5/57; H04N 7/01

(52) U.S. Cl. CPC H04N 17/04; H04N 9/64; H04N 7/0117; H04N 7/0127; H04N 5/57

(57) ABSTRACT

A method for intelligently configuring video settings includes steps of obtaining a video source information of a video source inputting a computer platform; obtaining a video performance information of the computer platform; and adjusting at least one image setting of the computer platform according to the video source information and the video performance information.

### CROSS-REFERENCE TO RELATED APPLICATION

This application claims priority to Taiwan Application Serial Number 107114738, filed Apr. 30, 2018, which is herein incorporated by reference in its entirety.

### BACKGROUND

### Field of Invention

The present invention relates to a method for configuring video settings. More particularly, the present invention relates to a method for automatically and intelligently configuring video settings of a computer platform.

### Description of Related Art

As users pay more attention to video quality, the parameters settings associated with image/video quality are more diverse. With the diversified development of the computer platforms, the image performance factors affecting the computer platform are also increasing. If the performance of the computer platform is incapable of processing relatively high quality images, the image processing is abnormal (for example, the platform execution speed is slow, malfunctioned, or error-handled).

### SUMMARY

The present invention provides a method for intelligently configuring video settings, thereby preventing abnormalities during recording or previewing a video source by a computer platform.

According to an embodiment of the disclosure, the method for intelligently configuring video settings includes steps of obtaining a video source information of a video source inputting a computer platform; obtaining a video performance information of the computer platform; and adjusting at least one image setting of the computer platform according to the video source information and the video performance information.

In an embodiment of the disclosure, the video performance information is a video processing capability of the computer platform.

In an embodiment of the disclosure, the video performance information is obtained by configuring at least one of a graphics processing capability of a central processing unit, a graphics processing capability of graphics processing unit and an image decompression capability.

In an embodiment of the disclosure, the video source information comprises dynamic range parameters, color depth parameters, color space parameters, image resolution parameters or frame rate parameters.

In an embodiment of the disclosure, adjusting the at least one image setting of the computer platform further includes a step of adjusting an image format for recording or previewing the video source.

In an embodiment of the disclosure, adjusting the at least one image setting of the computer platform further includes a step of reducing an image size for recording or previewing the video source.

In an embodiment of the disclosure, adjusting the at least one image setting of the computer platform further includes a step of lowering a frame rate for recording or previewing the video source.

In an embodiment of the disclosure, adjusting the at least one image setting of the computer platform further includes a step of lowering an encoding format for recording the video source.

In an embodiment of the disclosure, the method further includes a step of adjusting at least another image setting of the computer platform when the computer platform with the adjusted at least one image setting is unable to process the video source.

In an embodiment of the disclosure, obtaining the video performance information of the computer platform further includes a step of using a look-up table or performing an actual test to obtain the video performance information of the computer platform.

In an embodiment of the disclosure, the method further includes a step of detecting at least one component information of the computer platform before obtaining the video performance information of the computer platform.

In an embodiment of the disclosure, the method further includes a step of using the computer platform to receive the video source before obtaining video settings information of the video source.

In an embodiment of the disclosure, the method further includes a step of using the computer platform to receive the video source after adjusting the at least one image setting of the computer platform.

In an embodiment of the disclosure, the method further includes a step of determining whether the video performance information of the computer platform is able to process the video source before adjusting the at least one image setting of the computer platform according to the video source information and the video performance information.

In sum, the intelligent image adjustment method of the present invention can adjust the video/image quality setting used by the computer platform according to the obtained image signal source information and performance information of the computer platform such that the computer platform with the adjusted image quality setting can smoothly record or preview the video source, thereby preventing abnormalities.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a flow chart of a method for intelligently configuring video settings according to an embodiment of the disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The present invention provides a method for intelligently configuring video settings of a computer platform. This method can be integrated into a built-in function of an image capture card or an image capture box or by executing an associated image processing software in the computer platform.

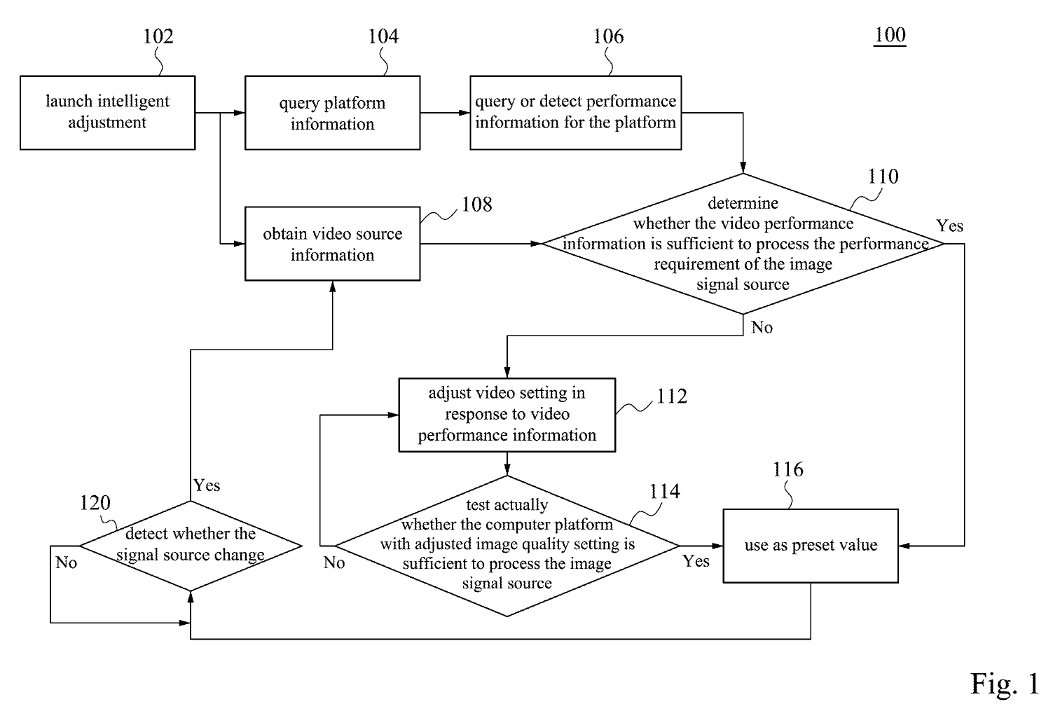

Reference is made to FIG. 1, which illustrates a flow chart of a method 100 for intelligently configuring video settings according to an embodiment of the disclosure. This method 100 includes the following steps.

In step 102, an intelligent adjustment process is launched or initialized in a computer platform. When a user selects the intelligent adjustment option or enters the intelligent adjustment function, the computer platform receives a start or an execute command to launch subsequent steps of the present invention. The intelligent adjustment function may be triggered by a selection button, a switch button, a touch switch or an enable function button displayed on a user interface in the computer platform, but not being limited thereto.

In step 104, a platform information of the computer platform is queried, e.g., to detect or query component information, such as the model and specifications of the platform hardware device. The component information may be a central processing unit (CPU) model, a graphics processing unit (GPU) model, a memory size, the speed of the bus, the chip type, and so on. The computer platform may be a single computing platform, and may also be composed of multiple computer platform units. For example, the multiple computer platform units may include a first computer platform unit for receiving an original video signal source, and a second computer platform unit for receiving an image signal source with the adjusted image quality, but not being limited thereto.

In step 106, a video performance information of the computer platform is detected or queried. For example, using a look-up table method and/or an actual test to obtain the video performance information of the computer platform. The video performance information may be at least one of the performance capability value, the performance score, the performance level, and the performance score, but is not limited thereto. In some embodiments, the performance information of various computer platforms or tested performance of various components can be collected and managed in a table that can be queried in this step. For example, the performance capability value of a central processing unit, the performance capability value of a graphics processing unit, and/or image decompression capability values may be collected and managed in this query table. In some embodiments, if the performance information is still not available associated with the platform information described above, the performance information of the computer platform can be actually tested. In some embodiments, step 104 may be omitted to directly detect the video performance information of the computer platform and keep performance information. In some embodiments, when the user agrees to upload performance information, the method of using big data may be proper to establish more accurate intelligent adjustment data. In some embodiments, steps 104, 106 may be performed at the first time when the execution software or hardware is installed in the computer platform. If the computer platform has no hardware changes, steps 104, 106 may not be performed again. In some embodiments, even if the computer platform has no hardware changes, it is also an option to perform steps 104, 106 again to obtain the video performance information of the computer platform once the intelligent adjustment function is triggered.

In step 108, a video source information of a video source input into a computer platform is obtained, and the video source information may include dynamic range parameters, color depth parameters, color space parameters, image resolution parameters or frame rate parameters. The dynamic range parameters may include high dynamic range (HDR) or standard dynamic range (SDR).

Step 108 may be performed concurrently with step 104 or step 106, or performed before or after step 104 or step 106. Moreover, step 108 may be performed before step 104 and step 106, or between step 104 and step 106, or after step 104 and step 106. In some embodiments, step 104 may be omitted, and step 108 may be performed concurrently with step 106, or performed before or after step 106.

Step 110 is configured to determine whether the computer platform with the video performance information is sufficient to process the performance requirement of the image signal source according to the obtained image signal source information and the video performance information. For example, determining whether the video performance of the computer platform is sufficient to process an original quality of the image source (e.g., record, preview, or otherwise process of the original quality of the image source).

If, in the judgment of step 110, the performance of the computer platform is sufficient to process the performance requirement of the image signal source, for example, the performance of the computer platform is sufficient to record or preview the input image signal source using an original image quality setting of the image signal source. In step 116, the setting parameter of the original image quality is used as a preset value.

If, in the judgment of step 110, the performance of the computer platform is insufficient to process the performance requirements of the video/image source, for example, the performance of the computer platform is insufficient to record, preview the input image signal source using an original image quality setting of the image signal source. The appropriate image quality for recording or preview the image signal source can be adjusted to match with the video performance of the computer platform in step 112 to avoid abnormal image processing.

The adjustment function in step 112 can be, for example, adjusting an image format used by the computer platform to record or preview the video/image source, reducing an image size used by the computer platform to record or preview the video/image source, lowering a frame rate used by the computer platform to record or preview the video/image source, or lowering an encoding format used by the computer platform to record the video/image source. Step 112 may utilize at least one of the foregoing exemplary options to enable the computer platform to record or preview the video signal source smoothly, but is not limited to the foregoing exemplary options.

The image format used for recording or previewing the video/image signal source may be, for example, P010, Y410, RGB, YUY2, NV12, etc., and the bit number or format used by each image format is different. Step 112 is configured to adjust the image format used for recording or previewing the video/image signal source according to the performance information of the computer platform.

The image size used for recording or previewing the video/image signal source may be, for example, 3840×2160, 2560×1440, 1920×1080 or 1280×720, etc. Step 112 is configured to adjust the image size used to record or preview the video/image source according to the performance information of the computer platform.

The frame rate used for recording or previewing the video/image signal source may be, for example, 240 Hz, 144 Hz, 120 Hz, 60 Hz, or 30 Hz. Step 112 is configured to adjust the frame rate used to record or preview the video/image signal source according to the performance information of the computer platform.

The encoding format used for recording the video/image signal source may be, for example, H264 or H265, and the color depth may be, for example, 8-bit or 10-bit. Step 112 is configured to select an encoding format used to record the image signal source according to the performance information of the computer platform.

In step 114, the computer platform is actually tested to record or preview the video/image signal source to determine if the adjustment of step 112 is appropriate. When the performance of the computer platform is sufficient to process the adjusted image quality setting, e.g., the computer platform is effective enough to use the adjusted image quality parameter to process the image signal source (e.g., recording, previewing, or other processing of the video/image signal source), the adjusted image quality parameter can be used as the preset value in step 116. When the performance of the computer platform is unable to process the adjusted image quality setting, the computer platform may be further adjusted to set another image quality of the video/image signal source, e.g., the performance of the computer platform is insufficient to use the adjusted image quality parameter to process the video/image signal source (e.g., recording, previewing, or other processing of the video/image signal source), that is, performing step 112 again, and adjusting the image quality setting of the image signal source used by the computer platform again such that a new image quality setting is different from the previous image quality setting used by the computer platform. In some embodiments, the image quality of the setting is lower than that of the previous adjustment of the image quality of the image signal source by the computer platform. For example, the image format is lowered from P010 to one of Y410, RGB, YUY2 and NV12. The image size is reduced from 3840×2160 to one of 3840×2160, 2560×1440, 1920×1080 and 1280×720. The frame rate is reduced from 240Hz to one of 144 Hz, 120 Hz, 60 Hz and 30 Hz. The color depth is reduced from 10-bit to 8-bit . . . etc. In addition, the computer platform may receive the video/image signal source before or after the step 112 (adjusting the image quality setting used by the computer platform). The video/image signal source may be a signal source including at least image data, such as an image or video signal, and is not limited thereto. In addition, in some embodiments, the actual test may be replaced by a message to prompt the user when there is a performance problem in actual use.

Since the signal source may change, step 120 is configured to continuously detect whether the signal source changes. When it is detected in step 120 that the signal source has changed, steps 108, 110, 112 need to be performed again as described above. When it is detected in step 120 that the signal source has not changed, it continuously detects whether the signal source changes.

Accordingly, the intelligent image adjustment method of the present invention can adjust the video/image quality setting used by the computer platform according to the obtained image signal source information and performance information of the computer platform such that the computer platform with the adjusted image quality setting can smoothly record or preview the video source, thereby preventing abnormalities.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for intelligently configuring video settings, comprising:
obtaining a video source information of a video source inputting a computer platform;
obtaining a video performance information of the computer platform; and
adjusting at least one image setting of the computer platform according to the video source information and the video performance information.

2. The method of claim 1, wherein the video performance information comprises a video processing capability of the computer platform.

3. The method of claim 1, wherein the video performance information is obtained by configuring at least one of a graphics processing capability of a central processing unit, a graphics processing capability of graphics processing unit and an image decompression capability.

4. The method of claim 1, wherein the video source information comprises dynamic range parameters, color depth parameters, color space parameters, image resolution parameters or frame rate parameters.

5. The method of claim 1, wherein adjusting the at least one image setting of the computer platform further comprising:
adjusting an image format for recording or previewing the video source.

6. The method of claim 1, wherein adjusting the at least one image setting of the computer platform further comprising:
reducing an image size for recording or previewing the video source.

7. The method of claim 1, wherein adjusting the at least one image setting of the computer platform further comprising:
lowering a frame rate for recording or previewing the video source.

8. The method of claim 1, wherein adjusting the at least one image setting of the computer platform further comprising:
lowering an encoding format for recording the video source.

9. The method of claim 1, further comprising:
adjusting at least another image setting of the computer platform when the computer platform with the adjusted at least one image setting is unable to process the video source.

10. The method of claim 1, wherein obtaining the video performance information of the computer platform further comprising:
using a look-up table or performing an actual test to obtain the video performance information of the computer platform.

11. The method of claim 1, further comprising:
detecting at least one component information of the computer platform before obtaining the video performance information of the computer platform.

12. The method of claim 1, further comprising:
using the computer platform to receive the video source before obtaining video settings information of the video source.

13. The method of claim 1, further comprising:
using the computer platform to receive the video source after adjusting the at least one image setting of the computer platform.

14. The method of claim 1, further comprising:
determining whether the video performance information of the computer platform is able to process the video source before adjusting the at least one image setting of the computer platform according to the video source information and the video performance information.
